(19) United States
(12) Patent Application Publication
(10) Pub. No.: US 2012/0086222 A1
(43) Pub. Date: Apr. 12, 2012

(54) SAFETY LATCH

(76) Inventor: Steven Weinstein, Summit, NJ (US)

(21) Appl. No.: 12/901,625

(22) Filed: Oct. 11, 2010

(51) Int. Cl. E05C 19/18

(52) U.S. Cl. 292/295

(57) ABSTRACT

A child safety latch with a removable catch piece. The latch can restrict access to cabinetry. The catch piece can be adjusted to allow the length of the latch to be varied so as to adapt to different cabinet/drawer configurations and to facilitate entry of adult fingers to operate the latch while simultaneously restricting the opening size to prevent access by a small child's hand. This latch may require the simultaneous depression of two buttons to disengage the catch piece so as to increase the degree of difficulty required to operate the latch beyond the capabilities of a child.

### BACKGROUND OF THE INVENTION

This invention relates to a device adding security to cabinetry, including cabinets, drawers and the like. Child safety latches can be mounted to cabinetry and prevent unwanted access by a small child and keep the cabinetry secure during disrupting forces such as an earthquake. Previous latches provide this function, but have applicability limited to a specific size and shape of cabinetry for which the latch was designed to secure. However, a typical house will have a variety of styles and sizes of cabinetry which are desirable to secure with a safety latch or homeowners may not know which latch is best suited for their cabinetry without trial and error and the accompanying frustrations.

Some previous latches are able to be operated by a child at an age younger than is desired by the caretakers. The child my learn how to operate an easily disengageable latch by observing a caretaker operate the latch.

A variety of latches can secure the variety of styles, shapes and sizes of cabinetry, but what is needed is a single latch system which has a broader spectrum of cabinetry for which the latch is appropriate and which may also be more difficult for a child to operate.

### SUMMARY OF THE INVENTION

An aspect of the safety latch includes a base with a cutout portion and a flexible flap coupled to the base and extending away from the base. A catch piece is coupled to the flap. A first button is flexibly coupled to said base and coupled to a first tab. The first tab has an orientation in which it is received in the cutout portion and a second orientation in which it is not received in the cutout portion. A second button is slidably engaged with the base and is coupled to the flap.

Another aspect of the invention includes a base and a catch piece having a first coupling portion. A flexible flap has a second coupling portion and is coupled to the base. The first and second coupling portions are engagable. The catch piece may be selectively fixed to the flap. A button has an engagement with the flap and is capable of being displaced relative to the base. Displacement of the button causes the flap to flex.

### BRIEF DESCRIPTION OF THE DRAWINGS

FIG. 1 shows an embodiment of a latch without the catch piece installed.

FIG. 2 shows a plurality of different types of catch pieces.

FIG. 3 shows an embodiment of a latch without the catch piece installed.

FIG. 4 shows view of the actuating arm and the cutout which receives the first and second tab portions.

### DETAILED DESCRIPTION OF THE PREFERRED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device and such further applications of the principles of the invention as illustrated therein being contemplated as would normally occur to one skilled in the art to which the invention relates.

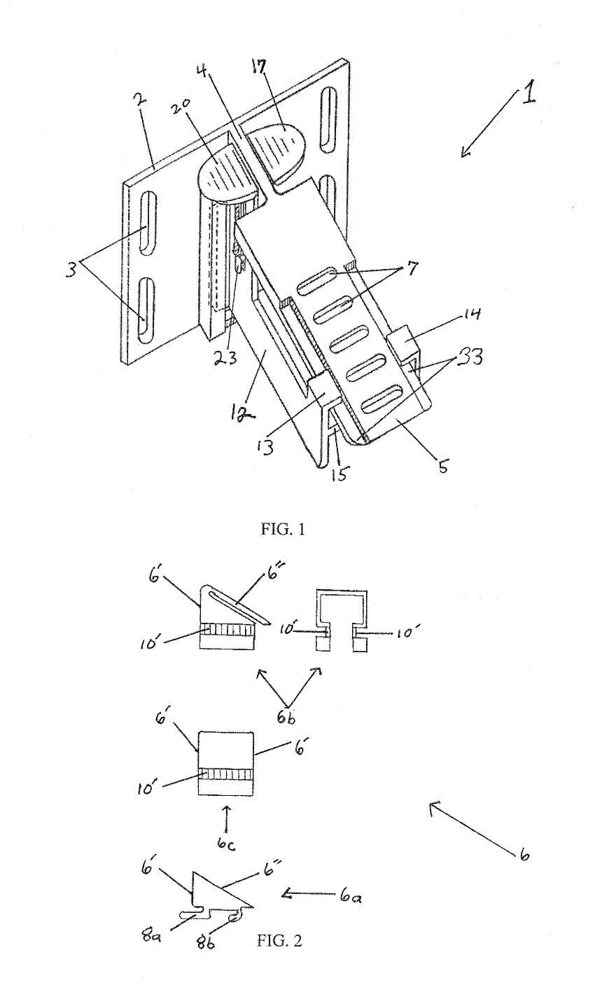

Referring to FIG. 1, the latch 1 has a base 2 which is secured to the inside of cabinetry. The base may be secured with an adhesive, but screws are preferred to mount the base to the cabinetry. The base may have one or more mounting holes 3 for fixing the base to the cabinetry with screws. The latch may be made of any suitable material, but a plastic material is preferred. For example, a plastic resin such as nylon would work well.

The base may include a planar member 4 which is substantially perpendicular to the surface to which the base is to be mounted. The planar member is coupled to flap 5 which extends away from the base. The flap is flexible and may be downwardly displaced. The flap is coupled to a catch point 6 such as those illustrated in FIG. 2. In some embodiments, the flap can receive the catch point in a plurality of positions at various distances from the base. The blunt end 6′ of the catch piece engages with the cabinetry frame and restricts access. The flap can be made to flex so that the catch piece can clear the cabinetry frame and provide access to the content inside. When the open cabinetry is closed the angled end 6″ of the catch piece will contact the cabinetry frame and be automatically flexed so that the catch piece slides past the frame. In some cabinetry a separate stop piece may be needed when the cabinetry is unsuitable or undesirable to engage the catch piece. The stop piece may be separately coupled to the cabinetry frame and engage the catch piece.

FIG. 2 shows side views of catch piece 6a, 6b, and 6c. An additional front view of catch piece 6b is shown. Catch piece 6c is an anti-pinch catch piece. Catch piece 6c has a blunt end 6′ on both sides of the catch. The catch piece 6c will not automatically slide past the frame when the cabinetry transitions from an open to closed. This can prevent accidental sudden closure of the cabinetry which could cause injury. Either type of catch piece may be used.

One embodiment for engaging the catch piece within the flap consists of a series of oval shaped flap holes 7 at varying distances from the base. The catch piece 6a has flexible small legs 8a, 8b that protrude from its underside and are slightly wider than any two adjacent flap holes when not compressed. The flexibility of the catch piece legs allows the catch piece to be squeezed for insertion into the flap holes. The legs are released and the catch piece is secured to the flap. Leg 8a extends under the flap and makes the catch piece more secure against displacement force exerted in an attempt to open cabinetry having an engaged latch. The catch piece can be squeezed again to release it from the flap holes. Removing the catch piece makes the latch inoperable which may be desirable for periods when simplified access to cabinetry content is desired and when children are not present which need to be kept from having simplified access to the content.

The catch piece may be removed and relocated to experiment in finding the optimal location for the catch piece. Drawers close to an overhanging counter or table may need to have the catch piece located farther from the base. Otherwise, the overhanging counter could restrict access needed to disengage the latch. The catch piece can be located in a variety of positions, one of which should be most suitable and desirable for the size and style of cabinetry and the size and shape of the hand which will be using the latch.

The preferred embodiment for receiving said catch piece in the flap is a rectangular slot 9 cut into the flap having a row of teeth 10 on each side of said slot as shown in FIG. 3. The catch pieces 6b and 6c have corresponding teeth 10′ on the outer side surfaces which will interface with the teeth 10 in slot. The catch piece is flexible and can be squeezed to a dimension smaller than the width of the slot and released back to its original size such that the teeth on the sides of the catch piece will mesh with the teeth in the slot to facilitate installation in the slot and hold the catch piece firmly in place. The interlocking teeth preferably provide the greatest resistance to displacement for a force exerted when attempting to open cabinetry having an engaged latch. The catch piece can be squeezed together again to allow fine or coarse adjustment of the distance of the catch piece from the base or removed altogether to make the latch inoperable.

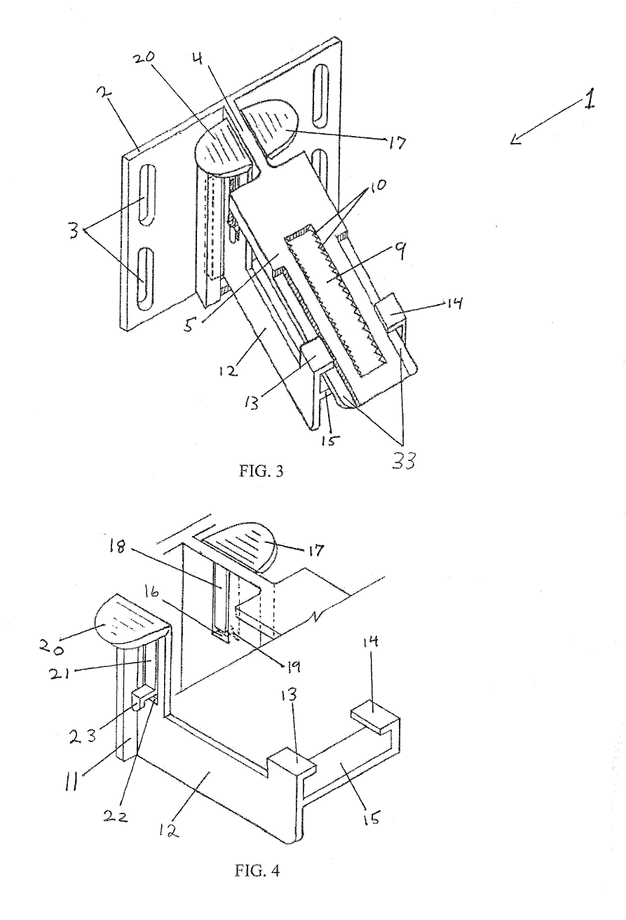

Base 2 has channel which receives flange 11 of an actuating arm 12 as show in FIG. 4. The actuating arm can slide within the channel and can slide adjacent to planar member 4. The actuating arm relays displacement force necessary to disengage the latch. The actuating arm extends away from the base and engages the flap. The actuating arms illustrated engage the half of the flap which is more distant from the base. The actuating arm should be more rigid than the flap so that the actuating arm may displace the flap.

The actuating arm may engage the flap with a first and second coupling portion 13, 14 as shown in FIG. 4. The first and second coupling portions of the actuating arm may be connected with a horizontal member 15 which spans the width of the flap. The first and second coupling portions each extend up from the horizontal member 15 and turn towards each other to engage the flap.

The flap and the engagement portions preferably mate together. The flap has routed-like portions 33 which receive the coupling portions. The combined thickness of the coupling portions received by the routed-like portions and the routed-like portions does not exceed the thickness of the rest of the flap so that the coupling portions do not catch any part of the cabinetry as the drawer or cabinet is opened or closed and the flap readily travels inward and outward.

Planar member 4 has a rectangular cutout 16. A first button 17 is flexibly coupled to the upper portion of the planar member. The first button may be at a right angle to the planar member. The planar member and the first button may be integrally formed with a thinner section of material coupling the planar member and the first button together so that the button may pivot at the thinner coupling point.

The first button has a first tab 18. The first tab is adjacent to the cutout in the planar member. The first tab is sized to be receivable within the cutout. The first tab is displaced into the cutout when force is applied to the first button. The first tab has a catch 19 which prevents the tab from rotating too far. Over rotation could cause stress on the coupling between the first button and the first tab.

The actuating arm is coupled to a second button 20. The second button is attached to the actuating arm via a thinner section of material to allow the button to flex slightly when depressed. The second button has a second tab 21 which protrudes down from the second button. There is a second rectangular cutout 22 in the section of the actuating arm which slides against the surface of the planar member. The second tab protrudes downward into the second cutout. When the second button is depressed the second tab will rotate towards the cutout in the planar member. Such rotation causes the second tab to engage the cutout whereby the bottom edge of the second tab contacts the bottom edge of the cutout in the planar member and prevents the actuating arm from sliding relative to the base. Thus, when force is only applied to the second button, the force is not relayed to the flap and the latch remains engaged. The second tab has catch 23 which prevents the tab from rotating too far and going past the edge of the cutout in the planar member. Damage to the latch system could occur if the tab is rotated too far.

If the first button is pressed before the second button on the actuating arm, the first tab will occupy the cutout. If the second button is pressed while the first tab is occupying the cutout, the second tab will not engage the cutout and will readily slide relative to the base. The actuating arm can then slide relative to the base and supply the actuating force to the flap to displace the flap and catch piece from the cabinetry frame.

In another embodiment the cutout in the planar member may be semi-permanently filled by a separate piece. This embodiment could be useful to provide the option either requiring only the second button to be pressed or the option of having to press the first and second button in sequence. In an alternative embodiment, the planar member may not include a cutout and only one button may be required to displace the flap and disengage the latch. In another embodiment the catch piece may be made integral with the flap and therefore not adjustable or removable.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected.

What is claimed:

1. A safety latch, comprising:
a base including a cutout portion;
a flexible flap coupled to said base and extending away from said base;
a catch piece coupled to said flap;
a first button flexibly coupled to said base and coupled to a first tab, said first tab having a first orientation in which said first tab is received in said cutout portion and a second orientation in which said first tab is not received in said cutout portion; and
a second button slidably engaged with said base and coupled to said flap.

2. The safety latch of claim 1, wherein said catch piece is detachably coupled to said flap.

3. The safety latch of claim 1, wherein said second button is coupled to said flap via an actuating arm connected to the half of the flap which is more distant from said base.

4. The safety latch of claim 1, wherein said second button is capable of relaying a force applied to said second button to said flap to cause said flap to flex.

5. The safety latch of claim 4, wherein said second button relays force to said flap when said first tab is received in said cutout portion.

6. The safety latch of claim 4, wherein said second button does not relay force to said flap when said first tab is not received in said cutout portion.

7. The safety latch of claim 6, wherein a force applied to said first button causes said first tab to be received in said cutout portion.

8. The safety latch of claim 7, wherein said second button is coupled to a second tab, said second tab having a first orientation in which said second tab is received in said cutout portion and a second orientation in which said second tab is not received in said cutout portion, and wherein said second button does not relay force to said flap when said second tab is received in said cutout portion.

9. The safety latch of claim 5, wherein said first tab is received in said cutout portion when a force is applied to said first button before a force is applied to said second button.

10. A safety latch, comprising:
a base;
a catch piece having a first coupling portion;
a flexible flap coupled to said base and having a second coupling portion, wherein said first coupling portion is engagable with said second coupling portion and said catch piece may be selectively fixed to said flap; and
a button having an engagement with said flap, said button capable of being displaced relative to said base and wherein displacement of said button causes said flap to flex.

11. The safety latch of claim 10, wherein said first coupling portion is engagable with said second coupling portion at a plurality of distances from said base.

12. The safety latch of claim 10, further comprising:
a locking tab coupled to said button, wherein said locking tab has an unlocked orientation which does not restrict said button from being displaced and wherein said locking tab has a locked orientation which does restrict said button from being displaced.

13. The safety latch of claim 12, further comprising:
a cutout portion in which said locking tab is receivable.

14. The safety latch of claim 13, further comprising:
an unlocking button; and
a second tab coupled to said unlocking button, said second tab having an orientation in which said second tab is received in said cutout portion and in contact with said unlocked orientation of said locking tab.

15. A safety latch, comprising:
a base with a cutout portion;
a flap coupled to said base and having a catch piece;
a first button having a first tab portion which is disengaged with said cutout portion in a first orientation and engaged with said cutout portion in a second orientation; and
an actuating arm having a second button with a second tab portion, said tab portion disengaged with said cutout portion in a first orientation and engaged with said cutout portion in a second orientation, wherein said second tab is blocked from engaging said cutout portion when said first tab engages said cutout portion, wherein said actuating arm is slidable relative to said base and said cutout portion, and a force applied to said actuating arm is relayed to said flap when said second tab is blocked from engaging said cutout portion.
